(19) United States
(12) Patent Application Publication
(10) Pub. No.: US 2015/0181821 A1
(43) Pub. Date: Jul. 2, 2015

(54) PREFABRICATED VERTICAL AQUAPONIC SYSTEM

(71) Applicant: Cheng Il PARK, Jeju-si Jeju-do (KR)

(72) Inventor: Cheong Il Park, Jeju-si Jeju-do (KR)

(21) Appl. No.: 14/419,254

(22) PCT Filed: Mar. 29, 2013
(86) PCT No.: PCT/KR2013/002644

§ 371 Date: Feb. 3, 2015

(30) Foreign Application Priority Data
Feb. 8, 2013 (KR) 10-2013-0014454

(51) Int. Cl. A01G 31/02

(52) U.S. Cl. CPC A01G 31/02

(57) ABSTRACT

A prefabricated vertical aquaponic system, including: a first plant pot part; a second plant pot part coupled to the lower portion of the first plant pot part so as to rotate with the first plant pot part; a rotatable rotation part positioned at the lower side of the second plant pot part; a tank part coupled to the lower portion of the rotation part and storing a nutrient solution; and an induction part which is extended from the tank part to the first plant pot part, connects the first plant pot part, the second plant pot part and the rotation part, rotates by the rotation part so as to rotate the first plant pot part and the second plant pot part, and induces the nutrient solution of the tank part to the first plant pot part.

### TECHNICAL FIELD

The present invention relates to an aquaponic system, and more particularly, a prefabricated vertical aquaponic system which can enhance a production efficiency per unit area of the fruits and vegetables or flowers and can farm fishes using food wastes and thus allow hydroponics using the excreta of the fishes as nutrient.

### BACKGROUND ART

It is a trend that a rate of living in multi-unit dwelling such as apartment or row house gradually increases. In particular, in a case of a large city, the rate of people's living in the multi-unit dwelling is above 80%. In the multi-unit dwelling of the large city, a chance to experience natural environment is low. Recently, in a case of the multi-unit dwelling of the large city, a park is constructed together in which people can enjoy the natural environment. Furthermore, veranda or interior space is frequently utilized to feel natural beauty by environmentally friendly growing of vegetables and landscaping also in the multi-unit dwelling. In this connection, environmentally friendly plant pots are used in which various fruits and vegetables or flowers can be planted and grown for feeling of natural beauty.

However, common plant pots are separately positioned in a row or suspended from branches of a tree or from a wall etc. for use in growing the fruits and vegetables or flowers. In such a case, the plant pots occupy a significant area. Furthermore, there is a demand for environmentally friendly and organic vegetables due to well-being fever. Accordingly, people want to grow the environmentally friendly and organic vegetables in an aquaponic manner. However, it is difficult to arrange time for managing an aquaponic system in a busy life. In addition, some extents of time and cost are required for obtaining nutrient solution (for example, environmentally friendly fertilizer) necessary for growth of environmentally friendly and organic vegetables and supplying the nutrient solution to the plant pots.

### SUMMARY OF THE INVENTION

### Technical Problems

An object of the present invention is to provide a prefabricated vertical aquaponic system which can smoothly produce the nutrient solution using the excreta of fishes as nutrient and evenly supply the nutrient solution to the plant pots.

Furthermore, another object of the present invention is to provide a prefabricated vertical aquaponic system which can enhance a production efficiency per unit area of the fruits and vegetables or flowers by reducing a spaces for growing the fruits and vegetables or flowers.

In addition, yet another object of the present invention is to provide a prefabricated vertical aquaponic system which breeds soldier flies with food waste to supply the fishes with high-protein feed and grows the vegetables by aquaponics using the excreta of the fishes.

### Solution to the Problem

The present invention discloses a prefabricated vertical aquaponic system comprising: a first plant pot part; a second plant pot part which is coupled to a lower portion of the first plant pot part so as to rotate with the first plant pot part; a rotation part which is positioned on a lower side of the second plant pot part and is rotatable; a tank part which is coupled to a lower portion of the rotation part and in which nutrient solution is stored; and a guide part which extends from the tank part to the first plant pot part to connect the first plant pot part, the second plant pot part and the rotation part and which is rotated by the rotation part to rotate the first plant pot part and the second plant pot part and which guides the nutrient solution inside the tank part to the first plant pot part, wherein the nutrient solution guided to the first plant pot part is supplied to the tank part through the second plant pot part and the rotation part, and wherein soldier flies are bred in the tank part, fishes are farmed using the soldier flies as feed, and the excreta of the fishes is used for producing the nutrient solution.

Furthermore, the present invention discloses the prefabricated vertical aquaponic system characterized in that each of the first plant pot part and second plant pot part comprises: a plant pot body part open at its top; and a plant pot cover part covering the top of the plant pot body part, wherein a body guide tube is protrudingly formed on an inner bottom surface of the plant pot body part and a plurality of body discharge holes are formed around the body guide tube, and wherein a nutrient solution space is concavely formed in the plant pot cover part, and a plurality of growing spaces are concavely formed around the nutrient solution space so as to be connected with the nutrient solution space, a cover guide tube is formed on an inner surface of the nutrient solution space, and a plurality of growing openings are formed in an inner surface of each of the growing spaces.

Furthermore, the present invention discloses the prefabricated vertical aquaponic system characterized in that each of the first plant pot part and the second plant pot part further comprises nutrient absorbing parts which are arranged over the nutrient solution space and the growing spaces and which absorb the nutrient solution in the nutrient solution space to guide it to the growing spaces.

Furthermore, the present invention discloses the prefabricated vertical aquaponic system characterized in that the growing spaces are mutually connected.

Furthermore, the present invention discloses the prefabricated vertical aquaponic system characterized in that the rotation part comprises: a rotation body part which is open at its top and is positioned on a lower side of the plant pot body part of the second plant pot part and into which the nutrient solution that has passed through the body discharge holes of the second plant pot part is introduced; a guiding part which is protrudingly formed along a circumference of the rotation body part and is inclined toward the tank part, gear teeth being formed at an end of the guiding part; a worm gear part which engages some of the gear teeth; and a rotation drive part which is connected with the worm gear part and rotates the worm gear part to thus rotate the rotation body part, wherein the nutrient solution introduced into the rotation body part flows along the guiding part to be supplied to the tank part.

Furthermore, the present invention discloses the prefabricated vertical aquaponic system characterized in that an outer surface of the plant pot body part of the second plant pot part is spaced apart from an inner surface of the rotation body part.

Furthermore, the present invention discloses the prefabricated vertical aquaponic system characterized in that a rotation guide tube is protrudingly formed on an inner bottom surface of the rotation body part and the plant pot body part of the second plant pot part is positioned above the rotation guide tube.

Furthermore, the present invention discloses the prefabricated vertical aquaponic system characterized in that the body guide tube, the cover guide tube and the rotation guide tube are protrudingly formed such that they are positioned in line with one another.

Furthermore, the present invention discloses the prefabricated vertical aquaponic system characterized in that the guide part comprises: a guide tube which is inserted in the body guide tube and cover guide tube of the first plant pot part, the body guide tube and cover guide tube of the second plant pot part, and the rotation guide tube of the rotation part while being in close contact therewith and which connects the tank part with the nutrient solution space of the first plant pot part; and a guide pump which is accommodated within the tank part and is connected with the guide tube and which causes the nutrient solution in the tank part to flow along the guide tube to be guided into the nutrient solution space of the first plant pot part.

Furthermore, the present invention discloses the prefabricated vertical aquaponic system characterized in that the tank part comprises: a tank body part which is open at its top and in which the fishes are farmed and the nutrient solution is produced by the use of the excreta of the fishes; a tank cover part covering the top of the tank body part; and a feed breeding part which is coupled with the tank cover part and in which the soldier flies are bred, the soldier flies being supplied to the inside of the tank body part, wherein on the tank cover part a rotation insertion hole is formed in which the rotation body part is inserted, and a tank growing space is concavely formed around the rotation insertion hole, and a plurality of tank openings are formed in an inner surface of the tank growing space, wherein a feed insertion hole is formed in the tank cover part, the feed breeding part is inserted in the feed insertion hole and coupled with the tank cover part, and a feed discharging hole is formed through a side wall of the feed breeding part, and the soldier flies are supplied as feed for the fishes to the tank body part through the feed discharging hole, and wherein an air introducing hole is formed in the tank cover part to allow air to be introduced into the inside of the tank body part.

Furthermore, the present invention discloses the prefabricated vertical aquaponic system characterized in that the nutrient solution flowing along the guiding part is introduced into the tank growing space and is supplied to the tank body part through the tank openings.

Furthermore, the present invention discloses the prefabricated vertical aquaponic system characterized in that on a lower surface of the guiding part, a rotation protrusion is protrudingly formed toward the tank cover, and a tank recessed portion is concavely formed on the tank cover part between the rotation insertion hole and the tank growing space so as to correspond to the rotation protrusion, and wherein when the rotation protrusion is inserted in the tank recessed portion, a plurality of contact balls are positioned between the rotation protrusion and the tank recessed portion.

Furthermore, the present invention discloses the prefabricated vertical aquaponic system characterized in that the tank cover part is inclined downward from the rotation insertion hole to the tank growing space.

Furthermore, the present invention discloses the prefabricated vertical aquaponic system characterized in that the tank part comprises: a floating body part which floats on a water surface and has a nutrient solution introducing hole formed at its top and below which the fishes are farmed, the nutrient solution being produced by the use of the excreta of the fishes; a floating cover part which closes the nutrient solution introducing hole of the floating body part; and a feed breeding part which floats on the water surface (10) while being spaced apart from the floating body part and in which the soldier flies are bred, the bred soldier flies being supplied as the feed for the fishes to the lower side of the floating body part, wherein formed on the floating cover part is a rotation insertion hole in which the rotation body part is inserted, and a tank growing space is concavely formed around the rotation insertion hole, and a plurality of tank openings are formed in an inner surface of the tank growing space.

Furthermore, the present invention discloses the prefabricated vertical aquaponic system characterized in that the feed breeding part comprises: a breeding body part which is open at its top and in which the soldier flies are bred; a body floating body which floats on the water surface and is connected with the breeding body part to float the breeding body part on the water surface; and a feed guiding part which is connected with the body floating part and encloses the breeding body part while being spaced apart from the breeding body part and which is in the form of screen, wherein the soldier flies are supplied to the water surface by the feed guiding part through the top of the breeding body part.

Furthermore, the present invention discloses the prefabricated vertical aquaponic system characterized in that the nutrient solution flowing along the guiding part is introduced into the tank growing space and is supplied to a lower side of the floating body part through the tank openings and the nutrient solution introducing hole.

Furthermore, the present invention discloses the prefabricated vertical aquaponic system characterized in that on a lower surface of the guiding part, a rotation protrusion is protrudingly formed toward the floating cover part, and a tank recessed portion is concavely formed on the floating cover part between the rotation insertion hole and the tank growing space so as to correspond to the rotation protrusion, and wherein when the rotation protrusion is inserted in the tank recessed portion, a plurality of contact balls are positioned between the rotation protrusion and the cover recessed portion.

Furthermore, the present invention discloses the prefabricated vertical aquaponic system characterized in that the floating cover part is inclined downward from the rotation insertion hole to the tank growing space.

### Effects of the Invention

The prefabricated vertical aquaponic system according to the present invention has the following effects:

(1) The prefabricated vertical aquaponic system according to the present invention includes the first plant pot part, the second plant pot part, the rotation part, the tank part and the guide part. The fishes are farmed in the tank part and the nutrient solution is produced using the excreta of the fishes as nutrient. Furthermore, the guide part connects the first plant pot part, the second plant pot part and the rotation part to guide the nutrient solution in the tank part to the nutrient solution space in the first plant pot part on uppermost side. The nutrient solution in the nutrient solution space is supplied back to the tank part via the first plant pot part, the second plant pot part and the rotation part. Therefore, the prefabricated vertical aquaponic system according to the present invention has an effect that it can smoothly produce the nutrient solution using the excreta of the fishes and evenly supply the produced nutrient solution to portions in which the fruits and vegetables or flowers are planted.

(2) The growing spaces are formed in the first plant pot part, the second plant pot part and the tank part of the prefabricated vertical aquaponic system according to the present invention and the fruits and vegetables or flowers are planted in the growing spaces. When the nutrient solution is supplied to the tank part via the stacked first plant pot part, second plant pot part and rotation part, the nutrient solution is introduced into the growing spaces to be used for growth of the fruits and vegetables or flowers. This can be continually performed by the guide part. Therefore, the prefabricated vertical aquaponic system according to the present invention has an effect that it can grow the fruits and vegetables or flowers without a separate managing work by an operator while enhancing a production efficiency per unit area of the fruits and vegetables or flowers with a stacked configuration.

(3) The tank part of the prefabricated vertical aquaponic system according to the present invention includes the body part, the cover part and the feed breeding part. The fishes farmed in the body part use the soldier flies as feed. In this connection, the soldier flies reproduce themselves using the food waste as feed in the feed breeding part. The soldier flies have a high reproductive rate and are bred in the feed breeding part to be frequently supplied as feed for the fishes. Therefore, the prefabricated vertical aquaponic system according to the present invention has an effect that it can smoothly supply the feed for the fishes while disposing of the food waste by the use of the soldier flies.

(4) In prefabricated vertical aquaponic system according to the present invention, the cover part of the tank part has the tank growing space. The tank growing space is a concavely formed space and the plurality of tank openings are formed in the inner surface of the tank growing space. The fruits and vegetables or flowers are planted in the tank growing space, and parts of roots of the fruits and vegetables or flowers extend through the tank openings to contact with the nutrient solution, thereby serving to purify the nutrient solution. Therefore, the prefabricated vertical aquaponic system according to the present invention has an effect that it can prevent degradation of the quality of water in the tank part.

### BRIEF DESCRIPTION OF THE DRAWINGS

FIG. 1 is an exploded perspective view of a prefabricated vertical aquaponic system according to a first preferred embodiment of the present invention;

FIG. 2 is a plane view illustrating a first plant pot cover part of the prefabricated vertical aquaponic system illustrated in FIG. 1;

FIG. 3 is a cross-sectional view illustrating the assembled prefabricated vertical aquaponic system illustrated in FIG. 1;

FIG. 4 is a perspective view illustrating an applied state of the prefabricated vertical aquaponic system illustrated in FIG. 1; and

FIG. 5 is a perspective view illustrating an applied state of a prefabricated vertical aquaponic system according to a second preferred embodiment of the present invention.

### BEST MODES FOR CARRYING OUT THE INVENTION

Hereinafter, referred embodiments of the present invention will be described in detail with reference to the attached drawings as follows. In describing the present invention, if particular description of related known functions or constructions are thought to unnecessarily obscure the gist of the present invention, detailed description thereof will be omitted.

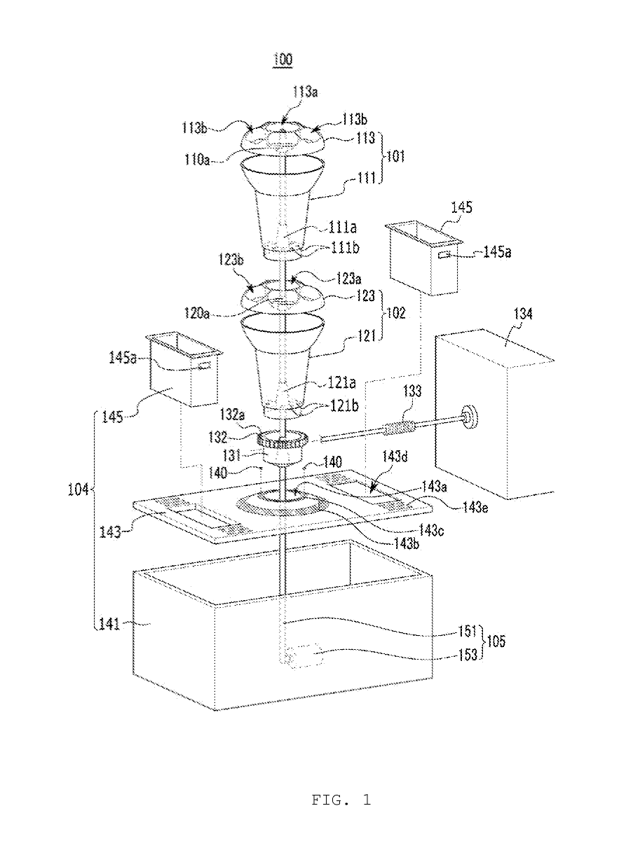

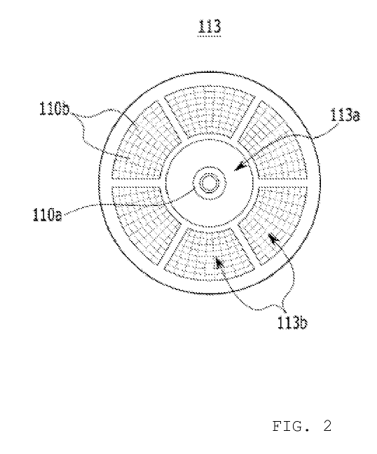

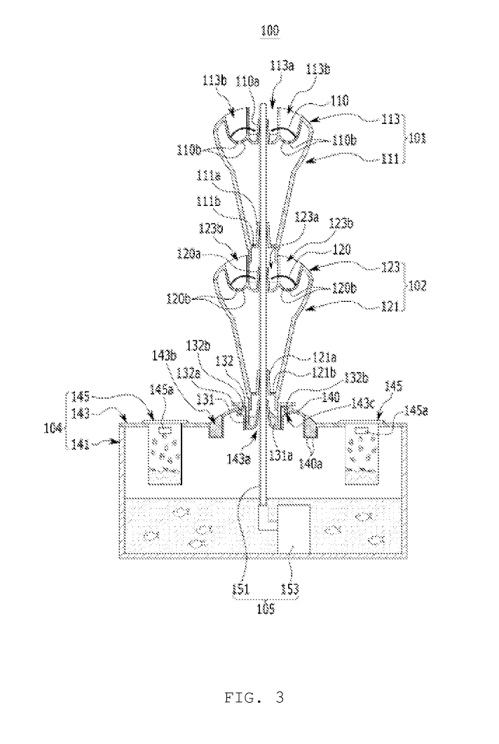

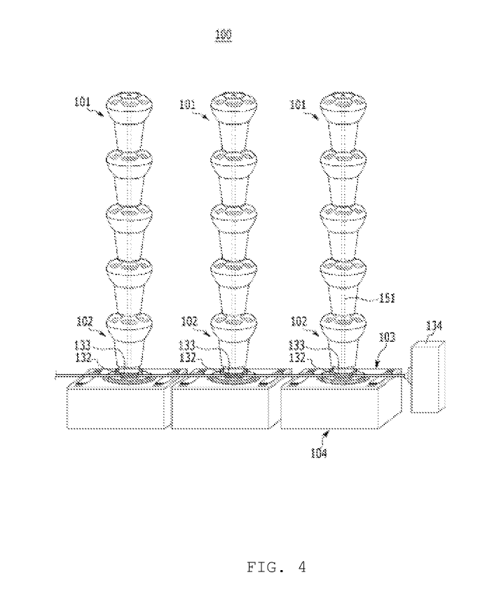

FIG. 1 is an exploded perspective view of a prefabricated vertical aquaponic system (100) according to a first preferred embodiment of the present invention, FIG. 2 is a plane view illustrating a first plant pot cover part (113) of the prefabricated vertical aquaponic system (100) illustrated in FIG. 1, FIG. 3 is a cross-sectional view illustrating the assembled prefabricated vertical aquaponic system (100) illustrated in FIG. 1, and FIG. 4 is a perspective view illustrating an applied state of the prefabricated vertical aquaponic system (100) illustrated in FIG. 1.

As illustrated in FIGS. 1 to 4, the prefabricated vertical aquaponic system (100) according to the first preferred embodiment of the present invention includes a first plant pot part (101), a second plant pot part (102), a rotation part (103), a tank part (104) and a guide part (105), and is used for growing fruits and vegetables or flowers by hydroponics by providing nutrient solution. Herein, the nutrient solution is a mixed solution of water and the excreta of fishes and the excreta of fishes act as nutrient for the fruits and vegetables or flower.

The first plant pot part (101) is positioned on an uppermost side of the prefabricated vertical aquaponic system (100) and includes a first plant pot body part (111) and a first plant pot cover part (113).

The first plant pot body part (111) is open at its top and has a first body guide tube (111a) and a first body discharge holes (111b). The first body guide tube (111a) is protrudingly formed on an inner bottom surface of the first plant pot body part (111) and the first body discharge holes (111b) are formed around the first body guide tube (111a) in the inner bottom surface of the first plant pot body part (111).

The first plant pot cover part (113) covers the top of the first plant pot body part (111). In the first plant pot cover part (113), a first nutrient solution space (113a) and first growing spaces (113b) are formed.

The first nutrient solution space (113a) is concavely formed in the first plant pot cover part (113), and the first nutrient solution space (113a) is provided with the nutrient solution. Furthermore, a first cover guide tube (110a) is formed on an inner surface of the first nutrient solution space (113a) and the first cover guide tube (110a) is positioned in line with the first body guide tube (111a).

The first growing spaces (113b) are concavely formed around the first nutrient solution space (113a) in the first plant pot cover part (113) and are connected with the first nutrient solution space (113a). Furthermore, the fruits and vegetables or flowers are planted in the first growing spaces (113b). The nutrient solution in the first nutrient solution space (113a) is introduced into the first growing spaces (113b), and is used for growing the fruits and vegetables or flowers. In this connection, first nutrient absorbing parts (110) extend over the first nutrient solution space (113a) and the first growing spaces (113b). The first nutrient absorbing parts (110) absorb the nutrient solution in the first nutrient solution space (113a) to guide it to the first growing spaces (113b).

Furthermore, a plurality of first growing openings (110b) are arranged in an inner surface of each of the first growing spaces (113b). In this connection, the first growing openings (110b) are preferably arranged in a net form and may each have various shapes such as rectangular shape, triangular shape, circular shape etc. Accordingly, some of the nutrient solution introduced into the first growing spaces (113) are used for growing the fruits and vegetables or flowers, and the rest are introduced into the first plant pot body part (111) through the first growing openings (110b) and are discharged to the outside through the first body discharge holes (111b).

Furthermore, the first growing spaces (113b) may be integrally formed while being mutually connected.

The second plant pot part (102) is coupled to a lower portion, i.e. the first plant pot body part (111) of the first plant pot part (101) so as to rotate with the first plant pot part (101). The nutrient solution which has passed through the first body discharge holes (111b) is introduced into the second plant pot part (102). Furthermore, the second plant pot part (102) includes a second plant pot body part (121) and a second plant pot cover part (123).

The second plant pot body part (121) is open at its top and has a second body guide tube (121a) and a second body discharge holes (121b). The second body guide tube (121a) is protrudingly formed on an inner bottom surface of the second plant pot body (121) and the second body discharge holes (121b) are formed around the second body guide tube (121a) in the inner bottom surface of the second plant pot body part (121).

The second plant pot cover part (123) covers the top of the second plant pot body part (121). In the second plant pot cover part (123), a second nutrient solution space (123a) and second growing spaces (123b) are formed.

The second nutrient solution space (123a) is concavely formed in the second plant pot cover part (123). The first plant pot body part (111) is arranged such that the first body discharge holes (111b) correspond to the second nutrient solution space (123a), and the first plant pot body part (111) of the first plant pot part (101) is inserted in the second nutrient solution space (123a). Thereby, the nutrient solution that passed through the first body discharge holes (111b) is supplied to the second nutrient solution space (123a). Furthermore, a second cover guide tube (120a) is formed on an inner surface of the second nutrient solution space (123a) and the second cover guide tube (120a) is positioned in line with the second body guide tube (121a) and also with the first body guide tube (111a) of the first plant pot body part (111).

The second growing spaces (123b) are concavely formed around the second nutrient solution space (123a) in the second plant pot cover part (123) and are connected with the second nutrient solution space (123a). Furthermore, the fruits and vegetables or flowers are planted in the second growing spaces (123b) as is the case with the first growing spaces (113b). The nutrient solution in the second nutrient solution space (123a) is introduced into the second growing spaces and is used for growing the fruits and vegetables or flowers. In this connection, second nutrient absorbing parts (120) extend over the second nutrient solution space (123a) and the second growing spaces (123b). The second nutrient absorbing parts (120) absorb the nutrient solution in the second nutrient solution space (123a) to guide it to the second growing spaces (123b).

Furthermore, a plurality of second growing openings (120b) are arranged in an inner surface of each of the second growing spaces (123b). In this connection, the second growing openings (120b) are preferably arranged in a net form and may each have various shapes such as rectangular shape, triangular shape, circular shape etc. Accordingly, some of the nutrient solution introduced into the second growing spaces (123b) are used for growing the fruits and vegetables or flowers, and the rest are introduced into the second plant pot body part (121) through the second growing openings (120b) and are discharged to the outside through the second body discharge holes (121b).

Furthermore, the second growing spaces (123b) may be integrally formed while being mutually connected, like the first growing spaces (113b).

As described above, the second plant pot part (102) has a configuration substantially identical to that of the first plant pot part (101).

Meanwhile, a plurality of plant pot parts having a configuration substantially identical to that of the first plant pot part (101) or second plant pot part (102) may be stacked between the first plant pot part (101) and second plant pot part (102). In such a case, a growing space for the fruits and vegetables or flowers grown using the plant pot parts may be increased several times. Thus, a production efficiency per unit area of the fruits and vegetables or flowers may be enhanced.

The rotation part (103) is positioned on a lower side of the second plant pot part (102) and is used for rotating the first plant pot part (101) and second plant pot part (102). The rotation part (103) includes a rotation body part (131), a guiding part (132), a worm gear part (133), and a rotation drive part (134).

The rotation body part (131) is open at its top and is positioned on a lower side of the second plant pot part (102), particularly, the second plant pot body part (121). Furthermore, the nutrient solution which has passed through the body discharge holes (121b) of the second plant pot body part (121) is introduced into the rotation body part (131). In this connection, an inner surface of the rotation body part (131) is spaced apart from an outer surface of the second plant pot body part (121).

Furthermore, a rotation guide tube (131a) is protrudingly formed on an inner bottom surface of the rotation body part (131) and the second plant pot body part (121) is positioned above the rotation guide tube (131a). Thus, the inner surface of the rotation body part (131) is kept spaced apart from the outer surface of the second plant pot body part (121). Furthermore, the rotation guide tube (131a) is positioned in line with the first and second body guide tubes (111a, 121a) and the first and second cover guide tubes (110a, 120a).

The guiding part (132) is protrudingly formed along a circumference of the rotation body part (131) and is inclined downward. That is, the guiding part (132) is inclined toward the tank part (104). Furthermore, gear teeth (132a) are formed at an end of the guiding part (132).

The worm gear part (133) engages some of the gear teeth (132a). In this connection, a rotation axis of the worm gear part (133) is orthogonal to a rotation axis of the gear teeth (132).

The rotation drive part (134) is connected with the worm gear part (133) and rotates the worm gear part (133). As the worm gear part (133) is rotated, the rotation body part (131) is also rotated about an axis of the guide part (105) together with the guide part (105). In this connection, the first plant pot part (101) and the second plant pot part (102) are also rotated together with the rotation body part (131). Thus, the fruits and vegetables or flowers planted in the first and second growing spaces (113b, 123b) undergo photosynthesis while being evenly exposed to the sunlight. Furthermore, deformation of the fruits and vegetables or flowers due to phototropism is prevented.

Furthermore, when the rotation body part (131) is rotated, the nutrient solution introduced into the rotation body part (131) may overflow the rotation body part and then flow along the guiding part (132) to be thus supplied to the tank part (104).

The tank part (104) is coupled with the rotation part (103), particularly, a lower portion of the rotation body part (131) and is supplied with the nutrient solution which has overflowed the rotation body part (131). Furthermore, the tank part (104) includes a tank body part (141), a tank cover part (143) and a feed breeding part (145).

The tank body part (141) is open at its top and stores the nutrient solution. The nutrient solution which has overflowed the rotation body part (131) flows into the tank body part. Furthermore, the fishes are farmed in the tank body part (141) and the nutrient solution is produced using the excreta of the fishes as nutrient. Thus, the nutrient solution can be smoothly produced for the prefabricated vertical aquaponic system (100).

Meanwhile, the tank body part (141) may be made of transparent material. In such a case, the fishes farmed inside the tank body part (141) can be observed from the outside, and thus the tank body part (141) may also function as a fishbowl.

The tank cover part (143) covers a top of the tank body part (141) and is coupled with a lower portion of the rotation body part (131). Formed in the tank cover part (143) are a rotation insertion hole (143a), a tank growing space (143b), a tank recessed portion (143c), a feed insertion hole (143d) and an air introducing hole (143e).

The rotation insertion hole (143a) is formed in the tank cover part (143) and the rotation body part (131) is inserted in the rotation insertion hole (143a).

The tank growing space (143b) is concavely formed around the rotation insertion hole (143a) in the tank cover part (143). Furthermore, the tank cover part (143) is inclined downward from the rotation insertion hole (143a) to the tank growing space (143b). Thus, the nutrient solution which has overflowed the rotation body part (131) can more smoothly flow to tank growing space (143b) while being guided by the tank cover part (143).

Furthermore, the fruits and vegetables or flowers are planted in the tank growing space (143b) as is the case with the first and second growing spaces (113b, 123b), and the nutrient solution which has overflowed the rotation body part (131) flows along the guiding part (132) and tank cover part (143) into the tank growing space (143b). Thus, the nutrient solution is used for growing the fruits and vegetables or flowers in the tank growing space (143b).

Furthermore, a plurality of tank openings (140a) are formed in an inner surface of the tank growing space (143b). In this connection, the tank openings (140b) are preferably arranged in a net form and may each have various shapes such as rectangular shape, triangular shape, circular shape etc. Accordingly, some of the nutrient solution introduced into the tank growing space (143b) are used for growing the fruits and vegetables or flowers, and the rest are introduced into the tank body part (141) through the tank openings (140a). Furthermore, parts of roots of the fruits and vegetables or flowers extend through the tank openings (140a) into the inside of the tank body part (141) and contact with the nutrient solution. In this case, the nutrient solution inside the tank body part (141) may be purified by the roots of the fruits and vegetables or flowers.

The tank recessed portion (143c) is concavely formed around the rotation insertion hole (143a). Furthermore, on a lower surface of the guiding part (132) of the rotation part (103), a rotation protrusion (132b) is protrudingly formed so as to correspond to the tank recessed portion (143c). When the rotation body part (131) is inserted in the rotation insertion hole (141a), the rotation protrusion (132b) is inserted in the tank recessed portion (143c). At this time, a plurality of contact balls (140) are positioned between the rotation protrusion (132b) and the tank recessed portion (143c). Thus, when the rotation part (103) rotates while being coupled with the tank part (104), the rotation part (103) can smoothly rotate due to reduction of friction by the contact balls (140). Furthermore, the contact balls (140) are kept in a state of being inserted in the tank recessed portion (143c).

The feed insertion hole (143d) is an opening for inserting the feed breeding part (145). The feed breeding part (145) can be kept in a state of being inserted in the feed insertion hole (143d) and coupled with the tank cover part (143).

The air introducing hole (143e) is an opening formed to allow air to be introduced into the inside of the tank body part (141). The air introduced into the inside of the tank body part (141) through the air introducing hole (143e) is supplied to the nutrient solution.

The feed breeding part (145) is inserted in the feed insertion hole (143d) and coupled with the tank cover part (143). Soldier flies are bred within the feed breeding part (145). Since the soldier flies utilize food waste as feed, the food waste is accommodated together within the feed breeding part (145). Furthermore, the soldier flies are used as high-protein feed for the fishes farmed in the tank body part (141).

Furthermore, a feed discharging hole (145a) is formed through a side wall of the feed breeding part (145). Since the soldier flies have a high reproductive rate, the population of the soldier flies increases while they are bred and thus the soldier flies are supplied to the tank body part (141) through the feed discharging hole (145a). Thereby, the soldier flies can be smoothly supplied as feed for the fishes. Furthermore, the excreta of the fishes is smoothly produced and thus the nutrient solution is also smoothly produced.

The guide part (105) extends through the first plant pot part (101), the second plant pot part (102) and the rotation part (103) to connect the tank part (104) with the first plant pot part (101). The nutrient solution inside the tank part (104) is supplied to the nutrient solution space (113a) of the first plant pot part (101) by the guide part (105). Furthermore, the guide part (105) includes a guide tube (151) and a guide pump (152).

The guide tube (151) extends through the first plant pot part (101), the second plant pot part (102) and the rotation part (103) and is fixed to the first body guide tube (111a), the first cover guide tube (110a), the second body guide tube (121a), the second cover guide tube (120a) and the rotation guide tube (131a) while being inserted therein and in close contact therewith. Thereby, when the rotation body part (131) of the rotation part (103) is rotated, the guide tube (151) is also rotated, thereby causing rotation of the first plant pot part (101) and the second plant pot part (102).

The guide pump (152) is connected with the guide tube (151) and accommodated within the tank part (104), particularly, the tank body part (141). The nutrient solution stored within the tank body part (141) flows along the guide tube (151) by means of the guide pump (152). The nutrient solution which has flowed along the guide tube (151) is introduced into the first plant pot part (101), particularly, the first nutrient solution space (113a).

The guide part (105) supplies the nutrient solution to the first plant pot part (101) and provides circulation of the nutrient solution in cooperation with the tank part (104) to which the nutrient solution is supplied back after passing through the first plant pot part (101), the second plant pot part (102) and the rotation part (103). Thus, the nutrient solution can be constantly circulated by the prefabricated vertical aquaponic system (100) and be thus used for growing the fruits and vegetables or flowers. Therefore, the prefabricated vertical aquaponic system (100) according to the present embodiment enables the fruits and vegetables or flowers to be grown in the first growing spaces (113b), the second growing spaces (123b) and the tank growing space (143b).

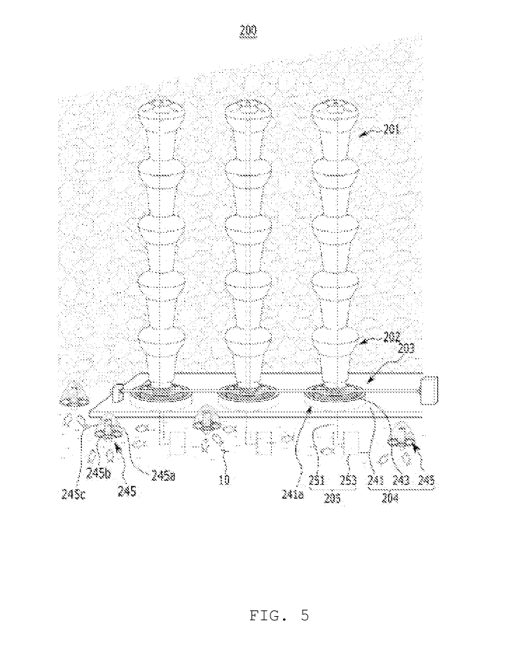

FIG. 5 is a perspective view illustrating an applied state of a prefabricated vertical aquaponic system (200) according to a second preferred embodiment of the present invention. As illustrated in FIG. 5, the prefabricated vertical aquaponic system (200) according to the second preferred embodiment of the present invention includes a first plant pot part (201), a second plant pot part (202), a rotation part (203), a tank part (204) and a guide part (205), like the prefabricated vertical aquaponic system (100) according to the first embodiment. The first plant pot part (201), the second plant pot part (202), the rotation part (203) and the guide part (205) have the same configuration as corresponding components of the prefabricated vertical aquaponic system (100) according to the first embodiment and only configuration of the tank part (204) is different from a corresponding component of the prefabricated vertical aquaponic system (100) according to the first embodiment. Therefore, the present embodiment will be described mainly with respect to the tank part (204). At this time, components of the first plant pot part (201), the second plant pot part (202), the rotation part (203), the tank part (204) and the guide part (205) will be described using the corresponding components of the prefabricated vertical aquaponic system (100) according to the first embodiment.

The tank part (204) floats on a water surface (10) and is coupled with the rotation part (203), particularly, a lower portion of the rotation body part (131; illustrated in FIG. 3). In this connection, the tank part (204) includes a floating body part (241), a floating cover part (243) and a feed breeding part (245).

The floating body part (241) floats on the water surface (10) and the fishes are farmed below the water surface (10). That is, the tank part (204) is installed on the water surface (10) without providing a separate space for storing the nutrient solution. Thus, the excreta of the fishes farmed is discharged below the water surface (10) and thus the nutrient solution is produced. At this time, the nutrient solution can be smoothly produced for the prefabricated vertical aquaponic system (200).

Furthermore, formed in the floating body part (241) is a nutrient solution introducing hole (241a) which allows the nutrient solution overflowing the rotation part (203) to be supplied to the water surface (10).

The floating cover part (243) closes the nutrient solution introducing hole (241a) of the floating body part (241). Furthermore, the floating cover part (243) is coupled with the lower portion of the rotation body part (131). The rotation insertion hole (143a), tank growing space (143b) and tank recessed portion (143c) as illustrated in FIG. 1 are formed in the floating cover part (243). Thereby, the floating cover part (243) provides the rotation of the rotation part (203) and is used for growing the fruits and vegetables or flowers by the use of the nutrient solution.

Meanwhile, the floating cover part (243) does not have components corresponding to the feed insertion hole (143d; illustrated in FIG. 1) and the air introducing hole (143e; illustrated in FIG. 1). Since unlike the feed breeding part (245) of the first embodiment, the feed breeding part (245) of the present embodiment is not coupled with the floating cover part (243), the feed insertion hole is not separately formed in the present embodiment. Furthermore, since the floating body part (241) floats on the water surface (10), the air is provided to the fishes through the part of the water surface (10) on which the floating body part (241) does not float, without passing through a separate air introducing hole.

The feed breeding part (245) floats on the water surface (10) while being spaced apart from the floating body part (241) and the soldier flies are bred within the feed breeding part. The bred soldier flies are supplied as feed for the fishes to the water surface (10) under the floating body part (241). Furthermore, the feed breeding part (245) includes a breeding body part (245a), a body floating part (245b) and a feed guiding part (245c).

The breeding body part (245a) is open at its top and the soldier flies are bred within the breeding body part. In this connection, the food waste is accommodated within the breeding body part (245a) and the food waste is used as feed for the soldier flies.

The body floating part (245b) floats on the water surface (10) and is connected with the breeding body part (245a) to float the breeding body part (245a). For example, the body floating part (245b) may be in a shape of ring formed of pipe and the breeding body part (245a) may be inserted in the ring.

The feed guiding part (245c) is connected with the body floating body (245b) and encloses the breeding body part (245a) while being spaced apart from the breeding body part (245a). Furthermore, the feed guiding part (245c) is in the form of screen. Thus, the feed guiding part (245c) also may function as insect-proof screen tent of the breeding body part (245a). Furthermore, the soldier flies are prevented from departing from a space defined by the feed guiding part (245c) passing through a top of the breeding body part (245a) and thus is naturally guided to an open lower side of the feed guiding part (245c), that is, to the water surface (10). Therefore, the bred soldier flies are supplied below the water surface (10) as feed for the fishes.

Furthermore, the above-described tank part (204) is configured to allow the prefabricated vertical aquaponic system (200) of the present embodiment to be applied to rivers, lakes, reservoirs and the like, particularly, fish farms.

In contrast to the first embodiment, a guide motor (252) of the guide part (205) is positioned below the water surface (10) and guides the nutrient solution to the first plant pot part (201) through a guide tube (251).

As above, the particular embodiments have been described, however, it is obvious to those skilled in the art that various modifications may be made without departing from the scope of the present invention. In addition, reference numerals in parentheses in the claims are for the purpose of preventing unclearness and the scope of claims should be interpreted including all reference numerals in parentheses.

### DESCRIPTION OF REFERENCE NUMERAL

100, 200: prefabricated vertical aquaponic system

101, 201: first plant pot part

102, 202: second plant pot part

103, 203: rotation part

104, 204: tank part

105, 205: guide part

110: first nutrient solution absorbing part

110a: first cover guide tube

110b: first growing opening

111: first plant pot body part

111a: first body guide tube

111b: first body discharge hole

113: second plant pot cover part

113a: first nutrient solution space

113b: first growing space

120: second nutrient solution absorbing part

120a: second cover guide tube

120b: second growing opening

121: second plant pot body part

121a: second body guide tube

121b: second body discharge hole

123: second plant pot cover part

123a: second nutrient solution space

123b: second growing space

131: rotation body part

131a: rotation guide tube

132: guiding part

132a: gear teeth

132b: rotation protrusion

133: worm gear part

134: rotation drive part

140: contact ball

140a: tank opening

141: tank body part

143: tank cover part

143a: rotation insertion hole

143b: storage growing space

143c: storage recessed part

143d: feed introducing hole

143e: air introducing hole

145: feed breeding part

145a: feed discharging hole

151: guide tube

153: guide pump

241: floating body part

241a: nutrient solution introducing hole

243: floating cover part

245: feed breeding part

245a: breeding body part

245b: body floating part

245c: feed guiding part

251: guide tube

253: guide pump

What is claimed is:

1. A prefabricated vertical aquaponic system comprising:
a first plant pot part;
a second plant pot part which is coupled to a lower portion of the first plant pot part so as to rotate with the first plant pot part;
a rotation part which is positioned on a lower side of the second plant pot part and is rotatable;
a tank part which is coupled to a lower portion of the rotation part and in which nutrient solution is stored; and
a guide part which extends from the tank part to the first plant pot part to connect the first plant pot part, the second plant pot part and the rotation part and which is rotated by the rotation part to rotate the first plant pot part and the second plant pot part and which guides the nutrient solution inside the tank part to the first plant pot part,
wherein the nutrient solution guided to the first plant pot part is supplied to the tank part through the second plant pot part and the rotation part, and
wherein soldier flies are bred in the tank part, fishes are farmed using the soldier flies as feed, and the excreta of the fishes is used for producing the nutrient solution.

2. The prefabricated vertical aquaponic system according to claim 1, wherein each of the first plant pot part and second plant pot part comprises:
a plant pot body part open at its top; and
a plant pot cover part covering the top of the plant pot body part,
wherein a body guide tube is protrudingly formed on an inner bottom surface of the plant pot body part and a plurality of body discharge holes are formed around the body guide tube, and
wherein a nutrient solution space is concavely formed in the plant pot cover part, and a plurality of growing spaces are concavely formed around the nutrient solution space so as to be connected with the nutrient solution space, a cover guide tube is formed on an inner surface of the nutrient solution space, and a plurality of growing openings are formed in an inner surface of each of the growing spaces.

3. The prefabricated vertical aquaponic system according to claim 2, wherein each of the first plant pot part and the second plant pot part further comprises nutrient absorbing parts which are arranged over the nutrient solution space and the growing spaces and which absorb the nutrient solution in the nutrient solution space to guide it to the growing spaces.

4. The prefabricated vertical aquaponic system according to claim 2, wherein the growing spaces are mutually connected.

5. The prefabricated vertical aquaponic system according to claim 2, wherein the rotation part comprises:
a rotation body part which is open at its top and is positioned on a lower side of the plant pot body part of the second plant pot part and into which the nutrient solution that has passed through the body discharge holes of the second plant pot part is introduced;
a guiding part which is protrudingly formed along a circumference of the rotation body part and is inclined toward the tank part, gear teeth being formed at an end of the guiding part;
a worm gear part which engages some of the gear teeth; and
a rotation drive part which is connected with the worm gear part and rotates the worm gear part to thus rotate the rotation body part,
wherein the nutrient solution introduced into the rotation body part flows along the guiding part to be supplied to the tank part.

6. The prefabricated vertical aquaponic system according to claim 5, wherein an outer surface of the plant pot body part of the second plant pot part is spaced apart from an inner surface of the rotation body part.

7. The prefabricated vertical aquaponic system according to claim 5, wherein a rotation guide tube is protrudingly formed on an inner bottom surface of the rotation body part and the plant pot body part of the second plant pot part is positioned above the rotation guide tube.

8. The prefabricated vertical aquaponic system according to claim 7, wherein the body guide tube, the cover guide tube and the rotation guide tube are protrudingly formed such that they are positioned in line with one another.

9. The prefabricated vertical aquaponic system according to claim 7, wherein the guide part comprises:
a guide tube which is inserted in the body guide tube and cover guide tube of the first plant pot part, the body guide tube and cover guide tube of the second plant pot part, and the rotation guide tube of the rotation part while being in close contact therewith and which connects the tank part with the nutrient solution space of the first plant pot part; and
a guide pump which is accommodated within the tank part and is connected with the guide tube and which causes the nutrient solution in the tank part to flow along the guide tube to be guided into the nutrient solution space of the first plant pot part.

10. The prefabricated vertical aquaponic system according to claim 5, wherein the tank part comprises:
a tank body part which is open at its top and in which the fishes are farmed and the nutrient solution is produced by the use of the excreta of the fishes;
a tank cover part covering the top of the tank body part; and
a feed breeding part which is coupled with the tank cover part and in which the soldier flies are bred, the soldier flies being supplied to the inside of the tank body part,
wherein on the tank cover part a rotation insertion hole is formed in which the rotation body part is inserted, and a tank growing space is concavely formed around the rotation insertion hole, and a plurality of tank openings are formed in an inner surface of the tank growing space,
wherein a feed insertion hole is formed in the tank cover part, the feed breeding part is inserted in the feed insertion hole and coupled with the tank cover part, and a feed discharging hole is formed through a side wall of the feed breeding part, and the soldier flies are supplied as feed for the fishes to the tank body part through the feed discharging hole, and
wherein an air introducing hole is formed in the tank cover part to allow air to be introduced into the inside of the tank body part.

11. The prefabricated vertical aquaponic system according to claim 10, wherein the nutrient solution flowing along the guiding part is introduced into the tank growing space and is supplied to the tank body part through the tank openings.

12. The prefabricated vertical aquaponic system according to claim 10, wherein on a lower surface of the guiding part, a rotation protrusion is protrudingly formed toward the tank cover, and a tank recessed portion is concavely formed on the tank cover part between the rotation insertion hole and the tank growing space so as to correspond to the rotation protrusion, and
wherein when the rotation protrusion is inserted in the tank recessed portion, a plurality of contact balls are positioned between the rotation protrusion and the tank recessed portion.

13. The prefabricated vertical aquaponic system according to claim 10, wherein the tank cover part is inclined downward from the rotation insertion hole to the tank growing space.

14. The prefabricated vertical aquaponic system according to claim 5, wherein the tank part comprises:
a floating body part which floats on a water surface and has a nutrient solution introducing hole formed at its top and below which the fishes are farmed, the nutrient solution being produced by the use of the excreta of the fishes;
a floating cover part which closes the nutrient solution introducing hole of the floating body part; and
a feed breeding part which floats on the water surface (10) while being spaced apart from the floating body part and in which the soldier flies are bred, the bred soldier flies being supplied as the feed for the fishes to the lower side of the floating body part,
wherein formed on the floating cover part is a rotation insertion hole in which the rotation body part is inserted, and a tank growing space is concavely formed around the rotation insertion hole, and a plurality of tank openings are formed in an inner surface of the tank growing space.

15. The prefabricated vertical aquaponic system according to claim 14, wherein the feed breeding part comprises:
a breeding body part which is open at its top and in which the soldier flies are bred;
a body floating body which floats on the water surface and is connected with the breeding body part to float the breeding body part on the water surface; and
a feed guiding part which is connected with the body floating part and encloses the breeding body part while being spaced apart from the breeding body part and which is in the form of screen,
wherein the soldier flies are supplied to the water surface by the feed guiding part through the top of the breeding body part.

16. The prefabricated vertical aquaponic system according to claim 14, wherein the nutrient solution flowing along the guiding part is introduced into the tank growing space and is supplied to a lower side of the floating body part through the tank openings and the nutrient solution introducing hole.

17. The prefabricated vertical aquaponic system according to claim 14, wherein on a lower surface of the guiding part, a rotation protrusion is protrudingly formed toward the floating cover part, and a tank recessed portion is concavely formed on the floating cover part between the rotation insertion hole and the tank growing space so as to correspond to the rotation protrusion, and
wherein when the rotation protrusion is inserted in the tank recessed portion, a plurality of contact balls are positioned between the rotation protrusion and the cover recessed portion.

18. The prefabricated vertical aquaponic system according to claim 14, wherein the floating cover part is inclined downward from the rotation insertion hole to the tank growing space.
